(19) United States
(12) Patent Application Publication
(10) Pub. No.: US 2025/0222742 A1
(43) Pub. Date: Jul. 10, 2025

(54) AUTOMOTIVE AIR VENT

(71) Applicant: HYUNDAI MOBIS CO., LTD., Seoul (KR)

(72) Inventor: Pil Jin JEON, Yongin-si (KR)

(73) Assignee: HYUNDAI MOBIS CO., LTD., Seoul (KR)

(21) Appl. No.: 18/888,976

(22) Filed: Sep. 18, 2024

(30) Foreign Application Priority Data
Jan. 9, 2024 (KR) 10-2024-0003592

(51) Int. Cl. B60H 1/00

(52) U.S. Cl. CPC B60H 1/00828; B60H 1/0065

(57) ABSTRACT

An automotive air vent including a housing including an open front defined therein, a rear wing horizontally extending and rotatably mounted inside the housing, and a knob connected to the rear wing, the rear wing rotating around a first rotation axis different from a second rotation axis of the knob, and the rear wing being configured to rotate in linkage with a rotation of the knob.

### CROSS REFERENCE TO RELATED APPLICATION

The present application claims the benefit under 35 USC § 119 (a) of Korean Patent Application No. 10-2024-0003592, filed Jan. 9, 2024, the entire contents of which is incorporated herein for all purposes by this reference.

### BACKGROUND

### 1. Field of the Invention

The present invention relates to an automotive air vent, and more particularly, to an automotive air vent advantageous for passenger protection by reducing the protrusion of the knob.

### 2. Description of the Related Art

Vehicle air conditioning relies on air vents to circulate conditioned air throughout the cabin. The air discharged into the vehicle can be adjusted to direct the airflow either towards or away from the passengers.

Inside the air vent, there are rear wings formed horizontally and front wings formed vertically. By moving the knob up and down or left and right, the rear wings and front wings can be adjusted to control the direction of the airflow.

The rear wing rotates around a hinge on one side, causing the knob to turn and potentially protrude forward from the air vent. To ensure passenger safety, Europe regulates protrusions above a certain height from the cockpit module's exterior base surface, so if the knob rotates and protrudes excessively, it may violate this regulation and necessitate design modifications.

Furthermore, when the knob is rotated downwards, it comes into close contact with the air vent housing, reducing the available space for users to grip the knob. Therefore, there is a need for an air vent design that prevents the knob from protruding towards the front while still allowing the user to easily operate the knob.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an automotive air vent including a housing including an open front defined therein, a rear wing horizontally extending and rotatably mounted inside the housing, and a knob connected to the rear wing, the rear wing rotating around a first rotation axis different from a second rotation axis of the knob, and the rear wing being configured to rotate in linkage with a rotation of the knob.

The rear wing may be configured to penetrate the knob.

The rear wing may be positioned on an upper side of the housing without being exposed to the open front of the housing.

A central portion of the rear wing may include an opening defined therein, the opening being arranged in a width direction of the rear wing to form a connecting portion and the knob may include openings defined therein through which the connecting portion penetrates.

The connecting portion may include a first connecting portion extending longitudinally at a front of the rear wing and a second connecting portion formed at a predetermined distance from the first connecting portion, and the openings defined in the knob may include a first through hole through which the first connecting portion penetrates and a second through hole through which the second connecting portion penetrates.

The first through hole and the second through hole may be formed in an elongated shape, allowing the first connecting portion and the second connection portion to move therein as the knob and the rear wing rotate.

The first through hole may be formed to curve circumferentially around the second rotation axis.

The rear wing may rotate around a center extending longitudinally along the first connection portion.

The knob may include a protruding portion extending from an upper surface of the knob.

The protruding portion may include a third through hole defined therein.

The first connecting portion, as the knob rotates upward, may maintain a fixed position inside the first through hole, and the first through hole is configured to slide along an outer side of the first connecting portion.

The second rotation axis may be located on a lower part of the knob.

the second through hole may be formed in a straight-line shape and is orientated tangentially to the second rotation axis.

In a general aspect, here is provided an air vent apparatus including a rear wing horizontally extending and rotatably mounted inside a housing, the rear wing having a first rotation axis and a knob connected to the rear wing, the knob having a second rotation axis different from the first rotation axis, the knob being configured to rotate the rear wing in combination with a rotation of the knob.

The rear wing may include a first connecting portion formed between a first end and a second end of the rear wing and a second connecting portion formed between the first end and the second end.

The knob may include openings defined therein through which the first connecting portion and the second connecting portion are provided.

The openings may include a first through hole and a second through hole, the first through hole and the second through hole being formed in an elongated shape, allowing the first connecting portion and the second connection portion to move therein as the knob and the rear wing rotate upon the rotation of the knob.

The first through hole may be formed to curve circumferentially around the second rotation axis.

The first rotation axis of the rear wing may be configured to be at a center of the first connecting portion and the second rotation axis of the knob may be located on the a lower part of the knob.

The air vent apparatus may include a second wing, the second wing being configured to be interlocked with the rear wing to be moved in unison upon the rotation of the knob.

### BRIEF DESCRIPTION OF THE DRAWINGS

FIG. 1 is a diagram illustrating an automotive air vent according to an embodiment of the present invention;

FIG. 2 is a perspective view illustrating a knob of an automotive air vent according to an embodiment of the present invention;

FIG. 3 is a perspective view illustrating a rear wing of an automotive air vent according to an embodiment of the present invention;

FIG. 4 is a perspective view illustrating the combined appearance of a rear wing and knob of an automotive air vent according to an embodiment of the present invention;

FIG. 5 is a cross-sectional view illustrating a rear wing and knob of an automotive air vent according to an embodiment of the present invention;

FIG. 6 is a diagram illustrating the motions of a rear wing and knob for upward airflow according to an embodiment of the present invention; and

FIG. 7 is a diagram illustrating the motions of a rear wing and knob for downward airflow according to an embodiment of the present invention.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Hereinafter, a description is made of the automotive air vent according to an embodiment of the present invention with reference to accompanying drawing, where identical or corresponding components are assigned the same reference numerals and repetitive descriptions are omitted.

To achieve a superior interior design and enhance the sense of spaciousness of the vehicle cabin, a slim air vent with an elongated air outlet and narrow vertical profile is employed in the cockpit module.

To create a luxurious design by concealing the rear wing from passengers' view, the rear wing is positioned atop the air outlet, allowing rear wing to be connected to the upper part of the knob.

When the rear wing is connected to the upper part of the knob and both rotate about the same axis, the rotation axis is positioned at the upper part of the knob, increasing the protrusion of the knob towards the user when operating the knob. In addition, depending on the placement of the knob, the space between the knob and the air outlet of the air vent is narrow, so there may be insufficient space for the user to grip the knob.

Meanwhile, when the knob protrudes towards the user, there is a concern that the occupants may be injured by colliding with the knob in the event of a vehicle collision. In Europe, the height of protrusions from the exterior base surface is regulated through interior fitting regulations, and it is also necessary to reduce the protrusion amount of the knob to comply with these regulations.

In the present invention, an automotive air vent is provided that can reduce the extent to which the knob 10 protrudes forward by setting the rotation axes of the knob 10 and the rear wing 20 differently.

FIG. 1 is a diagram illustrating an automotive air vent according to an embodiment of the present invention.

With reference to FIG. 1, an automotive air vent according to one embodiment of the present invention includes a housing 1 with an open front, a rear wing 20 extending horizontally and disposed rotatably inside the housing 1, and a knob 10 connected to the rear wing 20.

The front of the housing 1 may be open to allow air to be discharged, forming an air outlet in which a rear wing 20, front wing 40, and knob 10 may be arranged. The rear wing 20 may be extended horizontally, and the front wing 40 may be vertically positioned at predetermined intervals.

As shown in FIG. 1, the rear wings 20 and 30 may be arranged in pairs vertically. The pair of rear wings 20 and 30 may be arranged to be interlocked such that when the knob 10 is operated, both rear wings 20 and 30 move together (i.e., in unison). The pair of rear wings 20 and 30 may be positioned inside the housing 1 to prevent exposure at the front. The upper rear wing 20 may be positioned on the top of the housing 1, remaining concealed from the front. The knob 10 may be connected to at least one of the pair of rear wings 20 and 30. Users may operate the knob 10 to achieve upward or downward airflow. When the knob 10 is operated, the rear wing 20 connected to the knob 10 rotates to adjust the airflow, and the pair of rear wings 20 and 30 are interconnected to jointly adjust the airflow.

The knob 10 may be of any shape that facilitates comfortable and effective user operation. In this embodiment, the knob 10 is illustrated with a relatively large lower portion and a relatively small upper portion that connects to the rear wing 20. The lower portion serves as a part that users grip directly with their hands to provide operating force, designed relatively larger compared to the upper portion to facilitate easier operation.

The lower portion of the knob 10 may have a protruding shape at least partially towards the front. The knob 10 may serve as a handle, allowing users to manipulate the knob 10 through the protruding portion.

The upper portion of the knob 10 may be penetrated by the rear wing 20. That is, a through hole is formed in the upper portion of the knob 10, where at least a portion of the rear wing 20 is positioned as the rear wing 20 penetrates through the knob 10. The rear wing 20 and the knob 10 may be interconnected and operated together via the penetration mechanism.

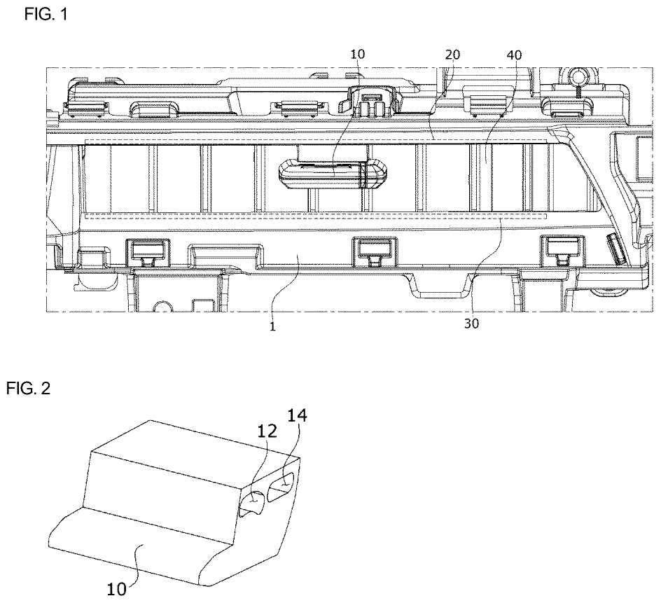

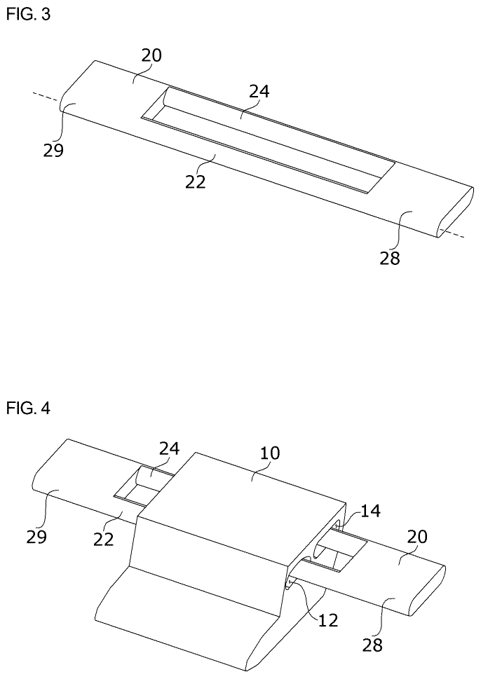

FIG. 2 is a perspective view illustrating a knob of an automotive air vent according to an embodiment of the present invention, FIG. 3 is a perspective view illustrating a rear wing of an automotive air vent according to an embodiment of the present invention, and FIG. 4 is a perspective view illustrating the combined appearance of a rear wing and knob of an automotive air vent according to an embodiment of the present invention.

With reference to FIGS. 2 to 4, the rear wing 20 and the knob 10 may be interconnected but rotate relative to each other about different axes. That is, during rotation, the rear wing 20 and the knob 10 may move relative to each other.

As shown in FIG. 2, the knob 10 may have through holes 12 and 14 formed in the upper portion thereof. In this embodiment, two through holes 12 and 14 are formed as shown in the drawing. The through hole formed in the front of the knob 10 is referred to as the first through hole 12, and the through hole formed in the rear is referred to as the second through hole 14.

With reference to FIG. 3, the center portion of the rear wing 20 may be hollowed to form cylindrical connecting portions. In this embodiment, two connecting portions are formed as shown in the drawing. There are no restrictions on the shape of the connecting portions 22 and 24, and the cylindrical shape is an example.

The connecting portion formed at the front of the rear wing 20 is referred to as the first connecting portion 22, and the connecting portion formed at the rear is referred to as the second connecting portion 24. The first connecting portion 22 and the second connecting portion 24 may penetrate through (i.e., be provided within) the first through hole 12 and the second through hole 14, respectively. In addition, the first connecting portion 22 and the second connecting portion 24 may be formed between a first end 28 of the rear wing 20 and an opposite, second end 29 of the rear wing.

The presence of the two connecting portions 22 and 24 facilitates complete transfer of forces between the rear wing 20 and the knob 10. As the rear wing 20 and the knob 10 rotate to adjust the airflow direction, having two connecting portions 22 and 24 allows for the knob 10 to be supported by each and to transfer force to the rear wing 20. There is no limit to the number of connecting portions 22 and 24, as long as facilitating easy transmission of force from the knob 10.

FIG. 4 illustrates the connection of the rear wing 20 and the knob 10 through the insertion of connection portions 22 and 24 into the through holes 12 and 14, respectively. The rear wing 20 and the knob 10 may rotate about different axes. To allow the knob 10 and the rear wing 20 to rotate about different axes when the user operates the knob 10 up and down, the knob 10 and the rear wing 20 may move relative to each other and rotate.

In this embodiment, the rear wing 20 is shown to rotate about the center of the first connecting portion 22 as the rotation axis 26. That is, the rear wing 20 may achieve upward or downward airflow by rotating about the center of the first connection portion 22. The two ends of the rear wing 20 are fixed to the housing 1. In detail, the two ends of the portion positioned along the extension line of the first connection portion 22 of the rear wing 20 may be fixed in such a way as to rotate as if suspended from the housing 1. The rear wing 20 may pivot around the center of the first connection portion 22, allowing the rear portion thereof to move up and down. That is, the first connection portion 22 of the rear wing 20 may rotate from a fixed position.

As shown in FIGS. 2 and 4, the through holes have an elongated slot shape. The first through hole 12 and the second through hole 14 may have different shapes to allow the knob 10 to rotate relative to the rear wing 20 around different axes. In this embodiment, the first through hole 12 may have a shape that at least partially circumscribes the rotation axis 16 of the knob 10. The rotation axis 16 of the knob 10 may be formed at the bottom of the knob 10 and close to the front of the knob 10.

Since the through holes 12 and 14 are elongated shapes, the connection portions 22 and 24 inside the through holes 12 and 14 may move relative to the knob 10. While the first connection portion 22 actually rotates from a fixed position, the first through hole 12 may move from the outer side of the first connection portion 22, allowing the knob 10 to rotate relative to the rear wing 20 around different axes. The second connection portion 24 may rotate relative to the first connection portion 22 and move inside the second through hole 14.

The width of the first through hole 12 and the second through hole 14 may be formed to correspond to the diameters of the first connection portion 22 and the second connection portion 24, respectively. That is, the first connection portion 22 and the second connection portion 24 may be arranged such that the ends inside the first through hole 12 and the second through hole 14 come into contact. The connection portions 22 and 24 may slide within the through holes 12 and 14, facilitating smooth rotational movement between the rear wing 20 and the knob 10 without displacement.

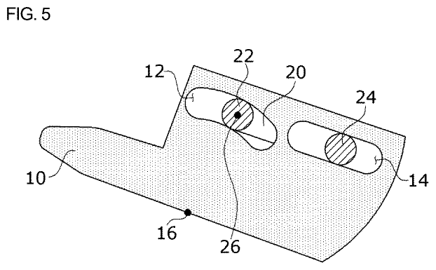

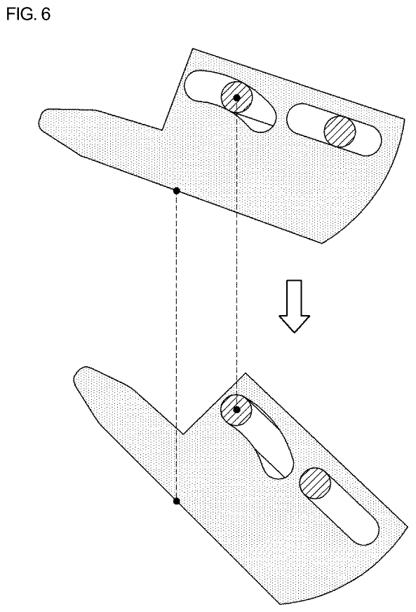

FIG. 5 is a cross-sectional view illustrating a rear wing and knob of an automotive air vent according to an embodiment of the present invention.

FIG. 5 shows the positions of the rotation axes 26 and 16 of the rear wing 20 and the knob 10. The rotation axis 26 of the rear wing 20 is formed at the center of the first connection portion 22, while the rotation axis 16 of the knob 10 may be formed at the bottom of the knob 10.

In conventional air vents, the knob 10 and the rear wing 20 shared a rotation axis. That is, the knob 10 also rotated based on the center of the first connection portion 22, causing the end of the knob 10 to protrude significantly forward due to the large distance between the end of the knob 10 and the center of rotation.

In this embodiment, the rotation axis 16 of the knob 10 is positioned downward, preventing the knob 10 from protruding forward by reducing the distance between the lower end of the knob 10 and the rotation axis 16 compared to conventional designs.

The first through hole 12 may be formed at least partially in a circular arc shape, with the center of this arc corresponding to the rotation axis 16 of the knob 10. Thus, when the knob 10 rotates, the first through hole 12 rotates around the center of the arc from the outer side of the first connection portion 22, allowing the knob 10 and the rear wing 20 to rotate around different axes. The second through hole 14 may be defined at least partially in a straight-line shape. In one example, an orientation of the straight-line shape of the second through hole 14 may be tangential to the to the rotation axis 16 of the knob 10.

There is no restriction on the location of the rotation axis 16 of the knob 10, and the rotation axis may also be positioned outside the knob 10. That is, a virtual rotation axis 16 may be formed outside the knob 10, and when drawing a circular arc centered on this virtual rotation axis 16, at least a portion may correspond to the shape of the first through hole 12.

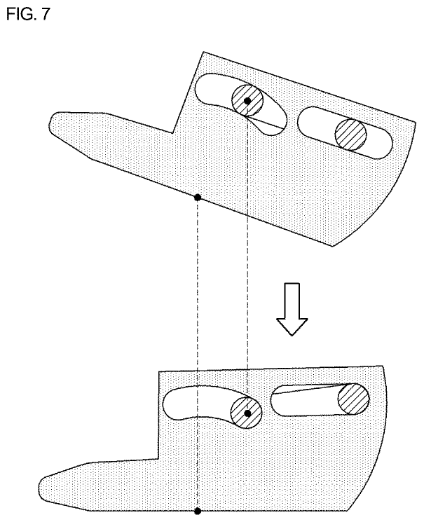

FIG. 6 is a diagram illustrating the motions of a rear wing and knob for upward airflow according to an embodiment of the present invention, and FIG. 7 is a diagram illustrating the motions of a rear wing and knob for downward airflow according to an embodiment of the present invention.

FIGS. 6 and 7 show the positions of the rotation axes 16 and 26 and the arrangement of the knob 10 and the rear wing 20 for generating upward and downward airflow. The rotation axes 16 of the knob 10 and 26 of the rear wing 20 may remain fixed while the knob 10 and rear wing 20 rotate.

When implementing upward airflow raising the front of the knob 10 as shown in FIG. 6, the knob 10 rotates upward around axis 16. The rear wing 20 is interconnected with the knob 10 via the first connection portion 22 and the second connection portion 24, allowing them to rotate together by transmitting force through these connecting portions 22 and 24.

The rear wing 20 rotates around the center of the first connecting portion 22 as the rotation axis 26, and the second connecting portion 24 formed at the bottom of the rear wing 20 moves downward with the second through hole 14, allowing the rear wing 20 itself to be arranged upward to implement upward airflow.

The first connection portion 22 and the second connection portion 24 may move relative to the inner sides of the first through hole 12 and the second through hole 14, allowing the knob 10 and rear wing 20 to rotate around different axes 16 and 26.

When implementing downward airflow by lowering the front of the knob 10 as shown in FIG. 7, the knob 10 rotates downward around axis 16. Similarly, the rear wing 20 rotates together with the knob 10 by receiving driving force through the first connection portion 22 and the second connection portion 24.

The rear wing 20 rotates around the center of the first connecting portion 22 as the rotation axis 26, and the second connection portion 24 moves upward with the second through hole 14, allowing the rear wing 20 itself to be arranged downward to implement the downward airflow.

Although the knob 10 and the rear wing 20 are described to interconnected through the first through hole 12, the second through hole 14, the first connection portion 22, and the second connection portion 24 in this embodiment, there is no limitation on the way of interconnecting the knob 10 and the rear wing 20.

For example, the knob 10 and the rear wing 20 may be interconnected through a slot and pin structure. To allow the knob 10 and the rear wing 20 to rotate around different axes while being interconnected, slots may be formed on both sides of the knob 10. The rear wing 20 may be divided into two parts relative to the knob 10. Pins may formed protruding on each side of the rear wing 20 facing the knob 10 and inserted into the slots.

The pins may slide and move inside the slots. Similar to the connection portions, two slots may be formed on the knob 10, and two pins may be formed on the rear wing 20 and placed inside the respective slots. The shape of the slots may correspond to the shape of the through holes, allowing the pins to slide inside the slots as the knob 10 rotates, resulting in relative movement.

Thus, similar to the connecting portions sliding inside the through holes, the knob 10 and the rear wing 20 may rotate around different axes through the slot and pin structure.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An automotive air vent, comprising:
a housing including an open front defined therein;
a rear wing horizontally extending and rotatably mounted inside the housing; and
a knob connected to the rear wing,
wherein the rear wing rotates around a first rotation axis different from a second rotation axis of the knob, the rear wing being configured to rotate in linkage with a rotation of the knob.

2. The automotive air vent of claim 1, wherein the rear wing is configured to penetrate the knob.

3. The automotive air vent of claim 2, wherein the rear wing is positioned on an upper side of the housing without being exposed to the open front of the housing.

4. The automotive air vent of claim 3, wherein a central portion of the rear wing includes an opening defined therein, the opening being arranged in a width direction of the rear wing to form a connecting portion, and
wherein the knob includes openings defined therein through which the connecting portion penetrates.

5. The automotive air vent of claim 4, wherein the connecting portion comprises:
a first connecting portion extending longitudinally at a front of the rear wing; and
a second connecting portion formed at a predetermined distance from the first connecting portion, and
wherein the openings defined in the knob includes a first through hole through which the first connecting portion penetrates and a second through hole through which the second connecting portion penetrates.

6. The automotive air vent of claim 5, wherein the first through hole and the second through hole are formed in an elongated shape, allowing the first connecting portion and the second connection portion to move therein as the knob and the rear wing rotate.

7. The automotive air vent of claim 6, wherein the first through hole is formed to curve circumferentially around the second rotation axis.

8. The automotive air vent of claim 7, wherein the rear wing rotates around a center extending longitudinally along the first connection portion.

9. The automotive air vent of claim 8, wherein the knob comprises a protruding portion extending from an upper surface of the knob.

10. The automotive air vent of claim 9, wherein the protruding portion includes the first through hole and the second through hole.

11. The automotive air vent of claim 8, wherein the first connecting portion, as the knob rotates upward, maintains a fixed position inside the first through hole, and the first through hole is configured to slide along an outer side of the first connecting portion.

12. The automotive air vent of claim 7, wherein the second rotation axis is located on a lower part of the knob.

13. The automotive air vent of claim 7, wherein the second through hole is formed in a straight-line shape.

14. An air vent apparatus, comprising:
a rear wing horizontally extending and rotatably mounted inside a housing, the rear wing having a first rotation axis; and
a knob connected to the rear wing, the knob having a second rotation axis different from the first rotation axis, the knob being configured to rotate the rear wing in combination with a rotation of the knob.

15. The air vent apparatus of claim 14, wherein the rear wing comprises:
a first connecting portion formed between a first end and a second end of the rear wing, and
a second connecting portion formed between the first end and the second end.

16. The air vent apparatus of claim 15, wherein the knob includes openings defined therein through which the first connecting portion and the second connecting portion are provided.

17. The air vent apparatus of claim 16, wherein the openings include a first through hole and a second through hole,
wherein the first through hole and the second through hole are formed in an elongated shape, allowing the first connecting portion and the second connection portion to move therein as the knob and the rear wing rotate upon the rotation of the knob.

18. The air vent apparatus of claim 17, wherein the first through hole is formed to curve circumferentially around the second rotation axis.

19. The air vent apparatus of claim 15, wherein the first rotation axis of the rear wing is configured to be at a center of the first connecting portion, and
wherein the second rotation axis of the knob is located on the a lower part of the knob.

20. The air vent apparatus of claim 14, further comprising:
a second wing, the second wing being configured to be interlocked with the rear wing to be moved in unison upon the rotation of the knob.
